(19) United States
(12) Patent Application Publication
(10) Pub. No.: US 2005/0273546 A1
(43) Pub. Date: Dec. 8, 2005

(54) Analog signal processor, as well as, a data register rewriting method and a data transmission method thereof

(76) Inventor: Hirofumi Tsujimura, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/971,069

(22) Filed: Oct. 25, 2004

(30) Foreign Application Priority Data
Jun. 8, 2004 (JP) 2004-169925

(51) Int. Cl. G06F 12/00

(52) U.S. Cl. 711/101; 711/220

(57) ABSTRACT

An analog signal processor, accessing to a setting register through serial communication, for achieving high speed of selective bit setting therein, comprising: an address register 3, a data register 4, a mask register 5, and a AND-OR logic circuit 6, wherein address data “a”, setting data “d” and mask data “m” are transmitted through serial communication. Reading out a register designated by the address data “a” and conducting AND operation on the mask data “m” for each bit thereof, and further conducting OR operation upon the setting data “d” for each bit thereof, a result obtained thereby is written back into a register 8 designated by the address data. When no mask data portion is transmitted, the same process is conducted, assuming that it is the mask data of all bits being zero.

### BACKGROUND OF THE INVENTION

The present invention relates to, so-called, an analog signal processor (Analog Signal Processor: ASP), being controllable from a controller side, which is made up with, such as, a microcomputer or the like, for example, through accessing to a resister provided within an inside thereof, via a serial communication, thereby enabling various kinds of signal processing in an analog manner therein, and it also relates to a data register rewriting method, for rewriting of setting data to such the analog signal processor, and further to a data transmission method for it.

Generally, the analog signal processor (ASP) is widely applied within various kinds of apparatuses, including, such as, an optical disk apparatus, for example, as being an LSI for use in analog signal processing, to be controlled by a microcomputer or the like, being a system controller, and for the purpose of conducting various kinds of analog signal processing therein.

Namely, within the ASP are provided registers, for storing a large number of setting conditions and/or setting values therein; such as, setting on gain and/or offset of an analog amplifier, setting on various kinds of selectors f or switching over the circuit structure depending upon an each kind of the disks, and further setting of switches for controlling valid/invalid of the functions thereof, for example. Further, those setting conditions and setting values are assigned into separate addresses of build-in or internal resisters within the ASP, and for setting/changing those setting conditions and setting values, an address and setting value data for selecting the register are given from the controller of an outside, via the serial communication or transmission, in general.

FIG. 16 attached herewith is a block diagram for showing an outlook of the serial communication or transmission, which is conducted between the ASP (LSI) relating to the conventional art mentioned above and a control microcomputer for controlling the settings therein. Thus, in general, the ASP (LSI) is constructed with a register divided into plural numbers of regions (i.e., addresses) and an interface (SCI) for use of the serial communication, and on the other hand thereof, for example, on a side of the controller, which is built up with the microcomputer or the like, there is also provided an interface (SCI) for use of the serial communication, as well as, a control microcomputer thereof. And, a signal to be transmitted through the serial communication between the ASP and the controller, it comprises, in general, an enable signal “SEN” indicative of a valid period of the communication, as well as, for selecting the LSI to be targeted, a synchronous clock signal “SCK” for determining a latch timing of data, and a serial data signal “SDT” to be the setting value data thereof. Further, those enable signal “SEN” and synchronous clock signal “SCK” are outputted from the controller side mentioned above. The serial data shown in the FIG. 16 is an example, for showing a method of sharing one (1) piece of a signal line as an input and an output, in common, however on the other hand thereof, there is also already known a method of constructing the input and the output, divided respectively, i.e., with two (2) signal lines.

FIG. 17 attached herewith a view for showing an example of a timing chart, for conducting the serial communication of the synchronous method as shown in FIG. 16 mentioned above. Herein, the enable signal “SEN” is of a positive logic; i.e., indicating the valid period of communication with an aid of “H (high)” level thereof, and further indicating a starting of communication with rise-up of the signal while an end of communication with fall-down of the signal. This time period defined by them is assumed to be a unitary serial communication.

In the serial communication of such the synchronous method, a sender (i.e., the controller side) outputs the serial data “SDT” at timing of the rise-up of the synchronous clock “SCK”, on the other hand, a receiver side (i.e., the ASP) takes the serial data “SDT” therein at timing of rise-up of the synchronous clock “SCK”. However, polarities of the enable signal “SEN” and the synchronous clock “SCK”, a frequency of the synchronous clock “SCK”, and timings, such as, a set-up time and a hold-time, etc., are determined depending upon each specification thereof.

And, since the object of the controller system, the structure of which was shown in the above, lies in accessing to the internal register within the analog signal processor (ASP) LSI, as being a target, then it is necessary to sent or transmit the address for selecting the register and the data to be written into the register, after producing them on the controller side mentioned above. Further, for bringing the communication to be bidirectional; i.e., an access of bothreading/writing is possible to the register, there is also needed information for indicating a direction of communication of the serial data. However, with the communication protocol in the synchronous-type serial communication, to be used for controlling such the analog signal processor (ASP), generally, it is often to send or transmit the serial data, being made of eight (8) bits, as a unit (a frame) thereof, and/or those made of the units of times of an integer. For example, the serial data “SDT” shown in FIG. 17 mentioned above is an example of the communication protocol built up with a signal of sixteen (16) bits; i.e., one (1) bit (i.e., R/W) indicative of the direction of communication is added at ahead thereof, while making up the address of seven (7) bits and the data of the register of eight (8) bits, thereby in total sixteen (16) bits.

Further, the timing shown herein is of a MSB First method, wherein an upper bit is transferred first on the in point of time, however, there is also known a LSB method, wherein a lower bit is transferred first. In the case of the latter, it means only that the order is reversed in an aligning of the bits within the frame of eight (8) bits; however, regarding the order of transmitting the data frame after transmitting the frame of direction/address, it is same to the above. Or, if the target of accessing is only writing into the LSI, the bit indicative of the direction is unnecessary, and also the direction of the data line is fixed. And, in such the case, it is not always necessary to transmit the address first, and then it is possible to adopt a communication protocol of transmitting, such as, data frame and then the address frame, in the order thereof.

Though differing from the analog signal processor, to which the present invention relates, however there is already known, such as, a receiver circuit to be built in a single-chip microcomputer, for example, and it is an example of the circuit for performing the serial data communication, in the Patent Document 1.

Patent Document 1: Japanese Patent Laying-Open No. Hei 6-161921 (1994).

As was mentioned in the above, within the analog signal processor (ASP), various kinds of setting conditions and setting values are set up, in a large number thereof, into the internal registers provided therein, however as was mentioned in the above, normally, each the register is built up upon the basis of the eight (8) bits length. Thus, each of the various kinds of settings and the setting values is different in the number of the setting bits, for each function thereof; such as, the following numbers of bits are necessary, 2-5 bits for the gain and/or the offset of the amplifier mentioned above, 1-3 bits for a selector and/or a switch, and 8-10 bits for a DA converter, for example. However, in the case of storing those various kinds of setting conditions and the setting values into the registers, each being built up upon the basis of eight (8) bits length (i.e., each address), respectively, as will be shown in FIG. 19, the internal register 110 must be large in the capacity thereof. For this reason, conventionally, it is common to assign or distribute different function bits, in a plural number thereof, to the same address, within the registers of the eight (8) bits length mentioned above.

Also, the ASP needs a large number of terminals, for example, input/output terminals for the analog signal, and terminals for the parts thereof, such as, external resisters and capacitors, etc., and for this reason, there is a limit in the number of pins of a package thereof. In addition thereto, with the ASP, the setting function thereof is a static one, basically; therefore, there is no necessity of accessing to the internal registers thereof at high speed. For this reason, serial communications are applied for accessing to the registers, and among of these, in particular a serial communication method of so-called clock synchronization type is applied in many cases, since it can be achieved with a circuit, being simple in the circuit structure and also small in the circuit scale thereof.

On a while, generally, for accessing (i.e., writing the setting condition or the setting value) into the register through the serial communication mentioned above, it is enough to make “write” operation, in other words, transmission thereof to the ASP. However, in the case where the function bits, each being different from each other, are assigned or distributed into the resistor of the same address, in the plural numbers thereof, as was mentioned in the above, and in particular, in the case when selectively re-writing only a specific setting and/or a setting value among the plural numbers of setting and the setting values, which are set up within the same address, thus, when setting up only a certain function bits, again, then there is necessity of a process of, so-called a “read modify write”, wherein the bits of setting target are renewed under the condition that data of that register are read out and holding the bit information other than the bits to be set up as they are, and thereafter, again, they are turned back into the same register. But, if achieving this “read modify write” process through the serial communication mentioned above, not only the transmission operation to the ASP, but also, there is further necessity of receiving operation for reading out the setting contents from the register, during the processing thereof.

Namely, in FIG. 18 is shown the “read modify write” process relating to the conventional art mentioned above, and as apparent from this figure, there are needed three (3) steps: i.e., a step (Step 1) for conducting the addressing from the controller to the register of the targeted LSI (Address) and reading of the data thereof (R_Data); a step (Step 2) for making data alternation upon the read-out data, at a predetermined bit(s) thereof, i.e., so-called the bit mask operation through software within the controller; and a step (Step 3) for writing (W_Data) a result of the bit mask operation into the address (Address) of the register as the data, again.

As was mentioned above, not only the transmission operation to the ASP, but also the receiving for reading the register, when conducting the “read modify write” process between the ASP and the controller through the serial communication, therefore, it takes a long time. However, if the system controller is made from a single-chip microcomputer having a clock synchronous type serial communication interference SCI module, for example, it is possible to obtain high speed communication, such as, being equal to several Mbps or higher than that, however in the case where no such the module there is provided therein, it is necessary to produce a clock through the software with using a port for common or general use, and in such the case, it comes down to about several hundreds kbps in the speed thereof. With this, it is impossible to obtain the communication at high speed, and also, for this reason, it comes up to be a problem on the processing speed of the controller.

In addition thereto, in the case of applying the communication of three (3) lines method, having the data lines of bi-directional, in relation to the conventional art mentioned above, there is also proposed an ASP, which has a timing specification of requiring a half clock or one (1) clock, so as to exchange the input/output of the data signal, for the purpose of protecting the data signals to be transmitted from colliding or bumping with each other. However, since the communication module of the microcomputer cannot cope with the timing of such the specialized specification, therefore in general, it must be deal with a method; i.e., while transmitting the signals with using the serial communication module, and thereafter receiving the signals through software, by switching over the port setting. For this reason, it is necessary to receive the signals (i.e., reading operation of the register), for an access of setting up the specific bits, in such the case, and therefore, there is a problem that it takes an access time, being equal to ten (10) times or more, comparing to the time of a simple write operation into the register.

However, as was mentioned in the above, since almost of the functions of the ASP, in general, are mainly static setting functions, and since many of them do not require high-speed accessing in particular, then even if conducting the “read modify write” process mentioned above through the serial communication, there is no chance that the processing speed thereof comes up to be a problem, in particular. However, regarding a certain part of the functions, and further the functions, which will be needed for the ASP in the future, there can be considered also a case of requiring such the accessing function at the high speed, as was mentioned, and in such the case, the speed of the serial communication comes to be a big problem.

### BRIEF SUMMARY OF THE INVENTION

Then, an object according to the present invention, for dissolving the problems in relation to the conventional arts mentioned above, in more details thereof, is to provide an analog signal processor having anew structure, for enabling the selective bit settings at high speed, into the registers to be accessed within the analog signal processor, and further a data register re-writing method and a data transmission method thereof, for achieving thereof.

For accomplishing the object mentioned above, according to the present invention, there is provided an analog signal processor, inputting a serial signal for setting data for use of analog setting, comprising: a data register of a predetermined bit length, for holding the data for use of analog setting therein; an address decoder for managing access to said data register; an extracting circuit for extracting an address signal for specifying an address within said data register, a data signal to be written into the address specified within said data register, and a mask signal for designating a specific bit of the address specified within said data register, from the serial signal inputted therein; and a re-writing circuit for selectively re-writing the data of the specific bit designated, at the address specified within said data register, upon basis of the address signal, the data signal and the mask signal, which are extracted by said extracting circuit.

Further, according to the present invention, in the analog signal processor as described in the above, it is preferable that said re-writing circuit conducts a process of logical operation upon the data to be written into the address specified within said data register, through a logical operation between said data signal and said mask signal, and further that said re-writing circuit conducts the logical operations of AND and OR.

Also, according to the present invention, in the analog signal processor as described in the above, it is preferable that said serial signal to be inputted further includes a signal for specifying a logical operation to be performed, and said re-writing circuit executes the logical operation specified by said logical operation specifying signal upon said data signal and said mask signal, thereby writing them into said address specified within said data register, or that said extracting circuit has a shift register. Furthermore, it is preferable that said extracting circuit further includes an address register for inputting and holding said address signal therein, a data register for inputting and holding said data signal therein, and a mask register for inputting and holding said mask signal therein.

Also, according to the present invention, for accomplishing the object mentioned above, there is provided a data register re-writing method, for rewriting data for use of analog setting, which is held within a data register of a predetermined bit length provided within an analog signal processor, comprising the following steps of: inputting data for setting up the data for use of analog setting into the analog signal processor through a serial communication from an outside; extracting an address signal for specifying an address within said data register, a data signal to be written into the specified address within said data register, and a mask signal for designating a specific bit of the address specified within said data register, from the serial signal inputted; and re-writing data of the designated specific bit at said specified address within said data register, selectively, upon basis of said address signal, said data signal and said mask signal.

Further, according to the present invention, in the data register re-writing method as described in the above, it is preferable that a logical operation is processed upon the data to be written into the specified address within said data register, through logically operating said data signal and said mask signal, and further that the logical operation processed upon said data signal and said mask signal is selectable.

Moreover, also for accomplishing the object mentioned above, according to the present invention, there is further provided a data transmission method, in accordance with serial communication, for rewriting data for use of analog setting, which is held within a data register of a predetermined bit length provided within an analog signal processor, comprising the following steps of: inputting data for setting up the data for use of analog setting into the analog signal processor through a serial communication from an outside; and communicating a serial signal, including an address signal for specifying an address within said data register, a data signal to be written into the specified address within said data register, and also a mask signal for designating a specific bit of the address specified within said data register.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the interior structure of an analog signal processor, according to one embodiment of the present invention;

FIG. 2 is a waveform view for showing input signals into the analog signal processor mentioned above;

FIG. 3 is a view for explaining the details of operations within the analog signal processor mentioned above;

FIG. 4 is also a view for explaining the details of operations within the analog signal processor mentioned above;

FIG. 5 is a circuit diagram for showing an example of a logic circuit portion for executing logical operations within the analog signal processor mentioned above;

FIG. 6 is a view for explaining an outline of a serial communication method to be conducted within the analog signal processor mentioned above;

FIGS. 7(a) and 7(b) are waveform views for showing timings of various signals when the serial communication method within the analog signal processor mentioned above;

FIG. 8 is a block diagram for showing the interior structure of the analog signal processor, according to a second embodiment of the present invention;

FIG. 9 is a waveform views for showing input signals into the analog signal processor, according to the second embodiment of the present invention;

FIG. 10 is a block diagram for showing the interior structure of the analog signal processor, according to a third embodiment of the present invention;

FIG. 11 is a waveform view for showing input signals into the analog signal processor, according to the third embodiment of the present invention;

FIG. 12 is a block diagram for showing the interior structure of the analog signal processor, according to a fourth embodiment of the present invention;

FIGS. 13(a) and 13(b) are waveform views for showing input signals into the analog signal processor, according to the fourth embodiment of the present invention;

FIG. 14 is a view for showing an example of logical operations to be executed within an arithmetic logical operation circuit, according to the fourth embodiment of the present invention;

FIG. 15 is a view for showing an example of pattern data stored into a pattern table within the analog signal processor, according to the fourth embodiment of the present invention;

FIG. 16 is a block diagram for showing an outline of the serial communication, which is conducted between the analog signal processor relating to the conventional art and a control microcomputer for controlling settings therein;

FIG. 17 is a view for showing an example of a timing chart of a synchronous-type serial communication shown in FIG. 16 mentioned above;

FIG. 18 is a view for showing an example of “Read Modify Write” within the system relating to the conventional art mentioned above; and

FIG. 19 is a block diagram for showing an example of the system relating to the conventional art mentioned above.

### DETAILED DESCRIPTION OF THE INVENTION

Hereinafter, embodiments according to the present invention will be fully explained by referring to the attached drawings.

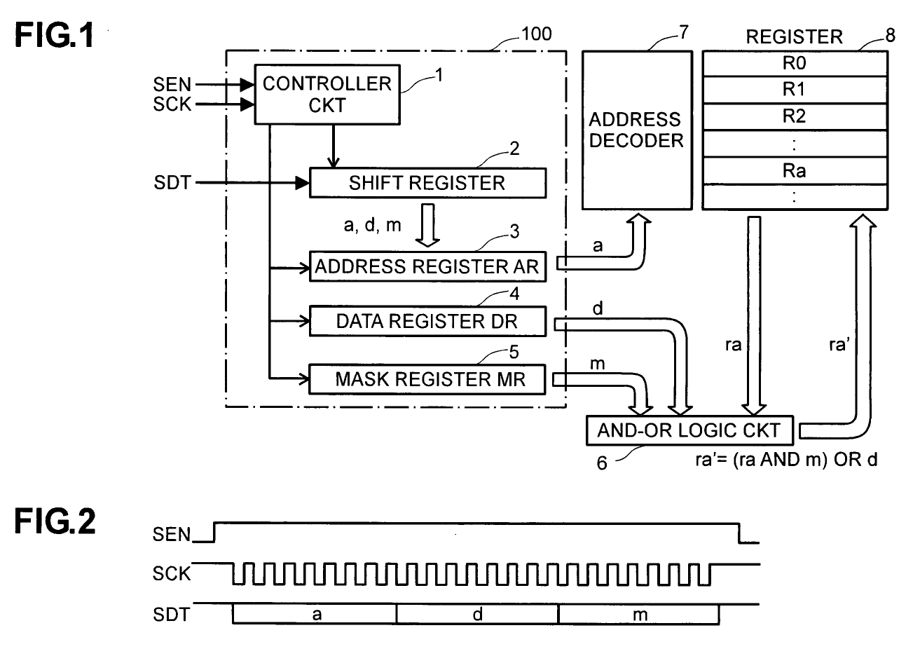

First of all, FIG. 1 shows the interior structure of an analog signal processor, according to one embodiment of the present invention, in the form of a block diagram thereof. Namely, as is shown in the figure, the analog signal processor, which is controlled upon build-in or internal registers, from a microcomputer of an outside, etc., for example, to be accessed through a serial communication, thereby enabling various kinds of settings in an analog manner therein, it comprises a serial communication interface (SCI) 100 for use of the serial communication, including therein a controller circuit 1, a shift register 2, and also three kinds of registers; such as, an address register (AR) 3, a data register (DR) 4 and a mask register (MR) 5, and further, a logic circuit portion 6, and registers 8 including an address decoder 7 therein.

Further, in such the structure mentioned above, an enable signal “SEN”, which is inputted through a serial communication path not shown in the figure, for indicating a valid period of communication and also selecting an LSI to be targeted, and also a synchronous clock signal “SCK” for providing a latch timing of data are inputted into the controller circuit 1 building up the communication interface (SCI) 100. On the other hand, a serial data signal “SDT”, as being the setting value data, is inputted into the shift register 2, which is controlled by the controller circuit 1 mentioned above, to be held therein, temporally, and thereafter it is transmitted to the three (3) kinds of registers, i.e., the address register (AD) 3, the data register (DR) 4 and the mask register (MR) 5, to be held therein, in accordance with a control signal from the controller circuit 1.

Namely, FIG. 2 shows the serial data signal “SDT”, as being the setting value data, (see the lower portion of the figure), as well as, the enable signal “SEN” which is inputted into the controller circuit 1. As is apparent from the figure, the serial data signal “STD”, as being the setting value data, is made up with three (3) kinds of data; i.e., address data (indicated by “a” in the figure), which is the data indicative of an address to be accessed within the registers 8 and is held within the address register (AR) 3, setting value data (indicated by “d” in the figure), which is the data to be written into the address of the registers 8 specified by the address data and is held within the data register (DR) 4, and mask data (indicated by “m” in the figure), which is the data for use of writing only into the specified bit(s), selectively with masking, when writing the setting data “d” into the address of the registers 8 specified by the address data, and is held within the mask register (MR) 5.

Herein, turning back to the FIG. 1 mentioned above, again, the address data “a” held within the address register 3 is supplied to the address decoder, and with an aid of the address data “a” is executed the access to the address of the registers 8. On the other hand, together with the setting data “d” held within the data register 4, the mask data “m” held within the mask register 5 is, for instance, in the present example, guided into a logic circuit portion 6 building up “AND-OR” logic, which will be mentioned later, and therein a predetermined logical operation process is executed on it. In more details thereof, in the present embodiment, upon the data “ra” obtained from the registers 8, which is accessed upon the basis of the address data “a” mentioned above, an operation is executed, which can be presented by the following logical operation equation, with using the data “d” of the data register and the mask data “m”:
ra′=(ra AND m) OR d (Eq. 1)

As a result, upon the “ra” obtained is executed writing operation (i.e., write) into the address of the registers 8, which is accessed by the address data “a”, thereby achieving re-writing thereof onto the bit(s) specified or designated by the mask data “m”, selectively, among the eight (8) bits stored within the specified address in the registers 8.

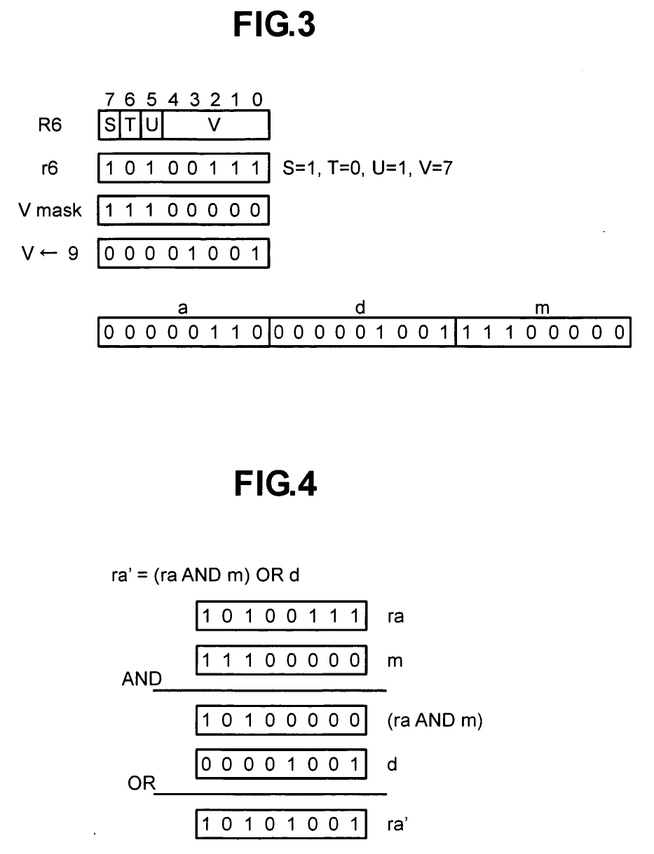

Next, explanation will be made about further details of the analog signal processor, according to the present invention, by referring to FIGS. 3 and 4, though the structure and the operation thereof was explained, briefly in the above.

FIG. 3 shows an example of four (4) kinds of setting conditions and the setting values, which are set up in the register “R6” of the address “6” of the registers 8. Namely, it is assumed that the address is “6”, the name of the register is “R6”, and the data of contents is “r6”. However, as was mentioned above, each register is made up with eight (8) bits (i.e., “7”-0 bits, in the figure). And, it is assumed that to this register R6 are assigned three (3) kinds of settings; i.e., “S=1”, “T=0” and “U=1”, each being made of one (1) bit (herein, for example, “1” indicates the ON condition while “0” the OFF condition) for indicating the “ON” or “OFF” condition of a selector and/or a switch, for example, and the setting value “V=7” (i.e., “4”-“0” bits in the figure) made up with five (5) bits, for setting up gain of an amplifier, for example. As a result thereof, into this register R6 is set up the data of eight (8) bits, “10100111”, as is shown by “r6” in the figure.

Herein, now, consideration is paid on the case where the re-writing is conducted, in particular, only upon the setting value “V=7”, for setting up the gain of the amplifier, among those four (4) kinds of setting conditions and setting values, which are set up in the register “R6”, thereby to reset it into “V=9”, for example. In this case, “Vmask=11100000” is set to be the mask data mentioned above. Further, herein “1” of each bit indicates that the mask is valid, i.e., the re-writing should not be conducted, while “0” of each bit that the mask is invalid, i.e., the re-writing should be conducted. Also, in this instance, the setting data “d” to be stored within the data register 4 is reset into “9” in the setting value “V”, therefore, as is indicated by “V←9” in the figure, it comes to be the setting value data of the eight (8) bits, “00001001”.

As is apparent from the above, as well as, the enable signal “SEN” and the synchronous clock signal “SCK”, the serial data “SDT” inputted into the controller circuit 1 is made up with three (3) frames; i.e., “00000110”, as being the address data “a” for indicating the address of the register 9, upon which the re-writing should be executed, “00001001”, as being the setting data “d” indicative of the contents of re-writing, and “1110000”, as being the mask data “m” for selectively indicating the bit(s) to be re-written. However, those signals and data are generated within the serial communication interface (SCI) including the microcomputer therein, for example, which is provided in an outside of the analog signal processor mentioned above.

On the other hand, explanation will be made about the operation of the analog signal processor mentioned above, and in particular, the logical operation process thereof when inputting the signal in accordance with the present invention through the serial communication, being constructed with, as was fully explained in the details thereof in the above, as well as, the enable signal “SEN” and the synchronous clock signal “SCK”, the serial data “SDT” made up with three (3) frames, each being made of a unit of eight (8) bits, including the address data “a”, the setting data “d” and the mask data “m”, by referring to FIG. 4 below.

Namely, as was mentioned in the above, within the analog signal processor, the serial data “SDT” inputted together with the enable signal “SEN” and the synchronous clock signal “SCK” is held within the shift register 2, once, and it is shifted to the address register 3, the data register 4 and the mask register 5, to be held therein, as is shown in the FIG. 1 mentioned above. And, by means of “00000110”, the address data “a” of eight (8) bits held within the address register 3, “ra(=r6)”, the data of eight (8) bits stored into the sixth address of the resisters 8 (=00000110), i.e., “10100111” is read out, and that data read out is guided into the logic circuit portion 6 building up the AND-OR logic therein.

On the other hand, the “00001001”, the data “d” which is stored within the data register 4, as well as, “1110000”, the data “m” which is stored within the mask register 5, they are also guided into the logic circuit portion 6 building up the AND-OR logic therein, in the similar manner, and the logical operation is executed therein, which is represented by the equation [Eq. 1] given in the above, upon each bit of the eight (8) bits data mentioned above. With this, as is shown in FIG. 4, the eight (8) bits data “ra′”, i.e., “10101001” can be obtained, to be written into the designated address. Thus, comparing the obtained data “ra′”=“10101001” to the eight (8) bits data “ra” stored into the sixth address of the register, i.e., “10100111”, it is apparent that it is obtained by alternating or changing, selectively, only remaining five (5) bits while removing the upper three (3) bits (i.e., the setting “S=1”, the setting “T=0” and the setting “U=1) therefrom, (in other words, the setting value “V=7”).

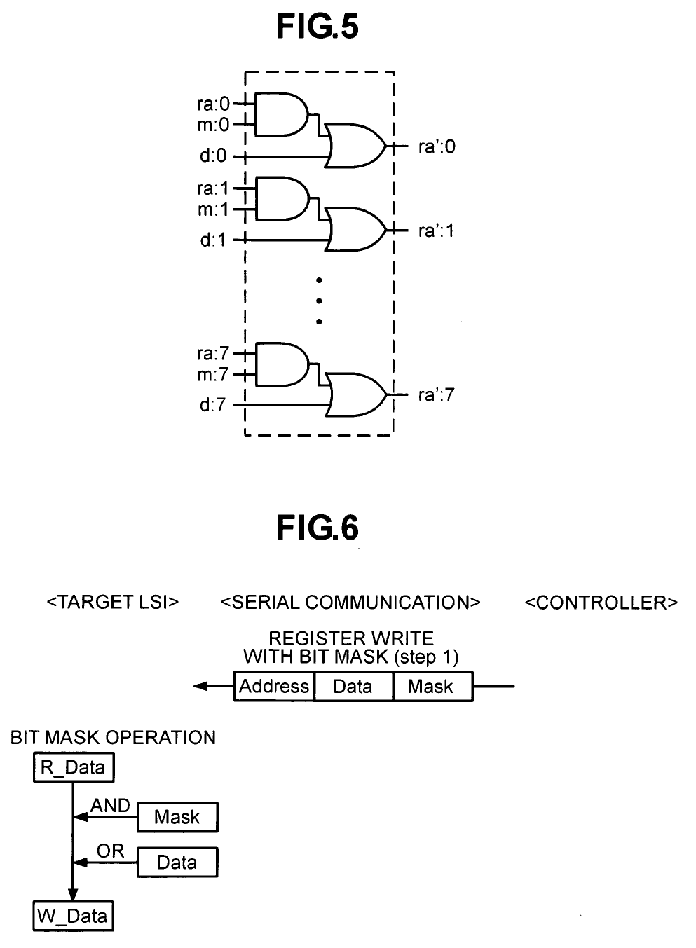

Further, an example of the logic circuit portion 6 for executing the logical operation mentioned above is shown in FIG. 5 attached herewith. Namely, the logic circuit is constructed with an AND circuit for inputting the “ra” and “m” for each bit of the eight (8) bits (i.e., “0”-“7”), and an OR circuit for inputting an output of the said AND circuit and the “d”.

As was mentioned in the above, within the analog signal processor according to the present invention, the details of which was explained in the embodiment mentioned above, and further with the serial data transmission method, which is applied therein, it is sufficient to generate a register write signal (for use of writing into the register), on the controller side, being attached with the bit mask (i.e., Mask) and comprising the address data (i.e., Address) and the setting data (i.e., Data) therein (Step 1), and to transmit it into the analog signal processor (ASP) LSI as the target, through the serial communication. On the other hand, on a side of the target LSI is conducted reading-out of data (R_Data) at a desired address from the registers 8, and upon the data read out is conducted the bit mask process, the details of which was mentioned in the above, by using the mask data (i.e., Mask) and the setting data (i.e., Data). And, thereafter, the data, upon which the operation process is conducted, is written into the address of the registers 8, again (W_Data). Thus, there is no necessity of conduction of the “Read Modify Write” process through the serial communication between the ASP and the controller, as was mentioned above in relation to the conventional art, and therefore, it is possible to achieve the communication at high speed, but the processing speed on the controller side does not comes out to be a problem.

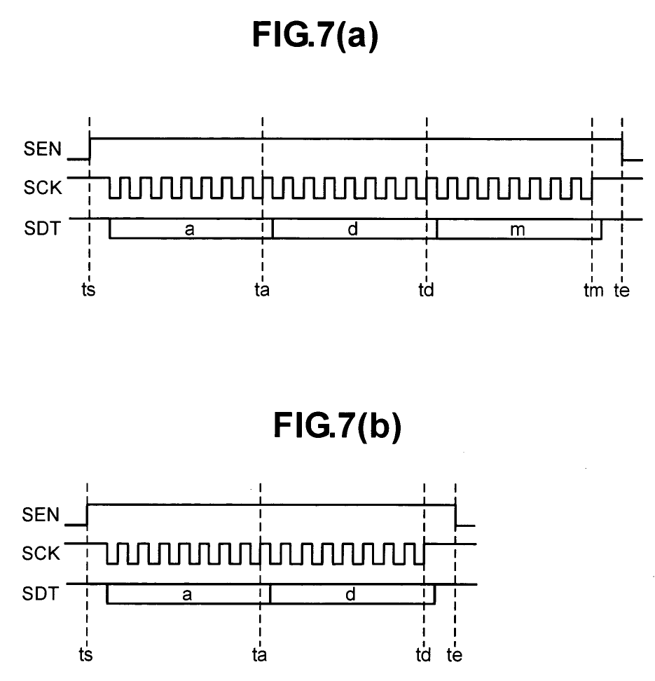

Further, FIGS. 7(a) and 7(b) show timings of the various signals when conducting the serial communication in the embodiment mentioned above, and in particular, FIG. 7(a) shows the transmission timing of the data, in general, which is constructed with the three (3) kinds of signals, i.e., the address data “a”, the setting data “d” and the mask data “m”. Namely, the serial data is loaded into the registers AR, DR and MR, at timings “ta”, “td” and “tm” where each eight (8) bits data is aligned with. However, in a case where one setting value is represented by the eight (8) bits data stored into a desired address of the registers 8, for example, there is no necessity of treating the mask upon the setting data at the said address. In such the case, for the serial data to be transmitted from the system controller side, it is not always necessary to built up into the structure mentioned above, but it may be constructed with, only the address data “a” and the setting data “d”, but removing the mask data “m” therefrom, as is shown in FIG. 7(b). In other words, it can be achieved by clearing the MR into “00000000”, at start timing “ts” of the serial communication.

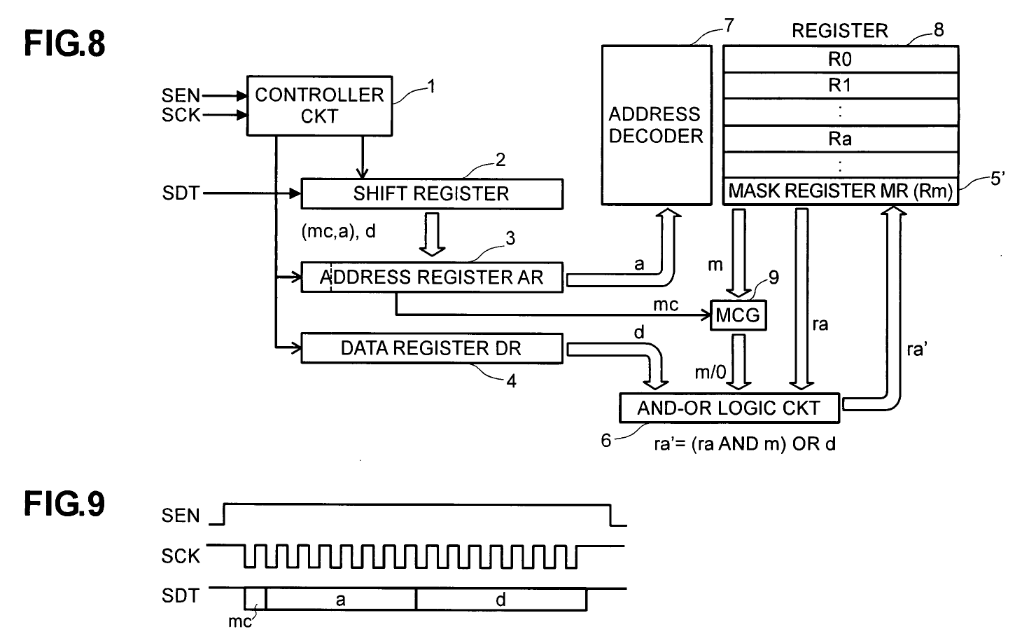

Next, FIG. 8 shows the analog signal processor, according to a second embodiment of the present invention. However, in the figure, the same reference numerals in the FIG. 1 mentioned above indicate the same constituent elements, and therefore, the detailed description thereof will be omitted herein. Namely, within the analog signal processor according to the second embodiment, as is apparent from the figure, an AND gate (MCG) 9 for use of controlling the mask is provided, in the place of the mask register (MR) 5 mentioned above. And, within the registers 8 mentioned above is further provided a mask register (MR (Rm)) 5′, into which a predetermined mask data is stored in advance.

On the other hand, FIG. 9 shows the structure of the serial data to be transmitted from the system controller side into the analog signal processor, according to the second embodiment. As is apparent from the figure, the setting value data to be transmitted together with the enable signal “SEN” and the synchronous clock signal “SCK”, i.e., the serial data “SDT”; it is constructed by providing a bit “mc” for determining the mask control to be valid/invalid, at a head thereof, while disposing the address data “a” and the setting value data “d”, one by one, at a rear thereof, as is shown in the figure.

With the analog signal processor according to the second embodiment mentioned above, the mask control bit “mc” at the head of the address register 3 is inputted into a control terminal of the AND gate (MCG) 9 for use of mask controlling, while from the registers 8 is read out the predetermined mask data stored into the mask register (MR (Rm)) 5′, to be outputted into the AND-OR logic circuit portion 6 through the AND gate (MCG) 9 for use of mask controlling.

Herein, in the same manner as was mentioned above, in the case where the mask is valid for the upper three (3) bits of the eight (8) bits data but is invalid for the other five (5) bits lower than that, for example, while storing “Rm=11100000” within the mask register (MR (Rm)) 5′ in advance, the head mask control bit “mc” of the address register 3 to be transmitted through the serial communication is set up to be valid (for example, into “1”). With this, the mask data “Rm” within the mask register (MR (Rm)) 5′ is outputted into the AND-OR logic circuit portion 6 through the AND gate (MCG) 9 for use of mask controlling. On the other hand, in a case when turning the mask into invalid, the heat mask control bit “mc” is set up to be invalid (for example, into “0”). With this, the AND gate (MCG) 9 for use of mask controlling is controlled, so that mask data for invalidating the masks (=“00000000”) to all of the bits, in the place of the mask data Rm(=“11100000”) mentioned above. Namely, this means that access can be made to the eight (8) bits data, as a whole, at the desired address within the registers 8.

In this manner, with the analog signal processor according to the second embodiment mentioned above, without accompanying great change on the protocol of serial transmission data relating to the conventional art, which is composed of the address data “a” and the setting data “d”, but it is possible to obtain the similar operation to that of the analog signal processor mentioned according to the embodiment mentioned above, only with the provision of the mask control bit “mc” of one (1) bit at a head (or a rear) of the address data “a”, for example. Further, within this second embodiment, it is also same that upon the data “ra” obtained from the register 8, which is accessed based on the address data “a”, is executed the operation, which is presented by the logical operation equation [Eq. 1] mentioned above, with an aid of the data “d” of the data register and the mask data “m”. Namely, with this second embodiment, it is also possible to achieve the re-writing of the contents, selectively, upon the specified bit(s) indicated or designated by means of the mask control signal “mc”, onto the address of the registers 8, to which accesses is made in accordance with the address data “a”, in the similar manner.

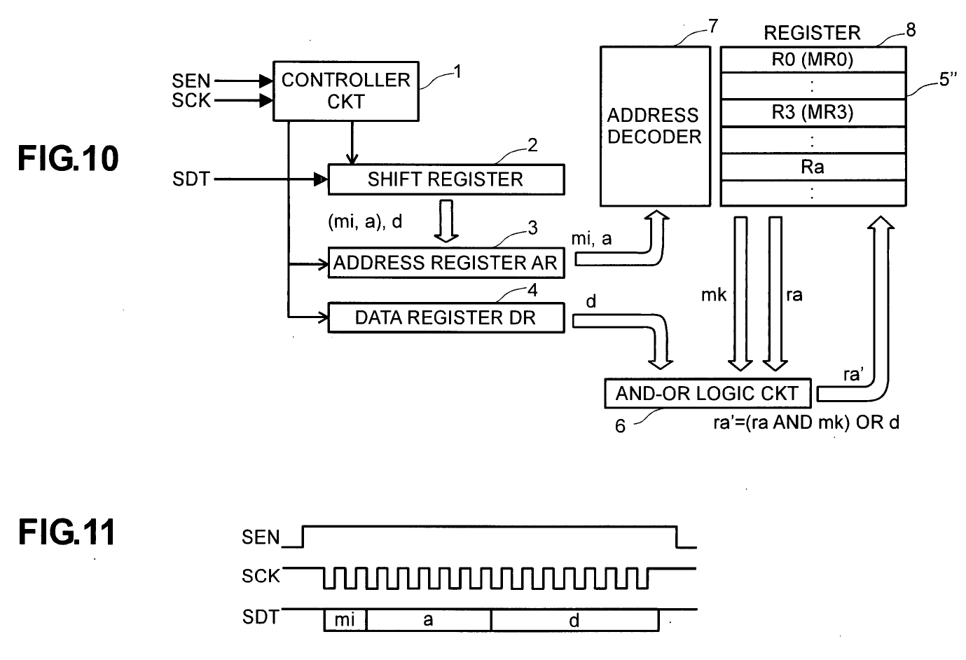

Next, FIG. 10 shows the analog signal processor according to a third embodiment of the present invention. However, in this figure, the same reference numerals in the FIG. 1 mentioned above depicts the same constituent elements, and therefore the detailed explanation thereof will be omitted, herein. Thus, in this third embodiment, as is apparent from the figure, while deleting the mask register (MR) 5 mentioned above, a mask registers 5″ is provided within the registers 8, into which plural numbers of mask data (R0 (MR0)−R3 (MR3)) are stored in advance.

Also, FIG. 11 attached herewith shows the structure (i.e., the protocol) of the serial data to be transmitted from the system controller side to the analog signal processor according to the third embodiment. As is apparent from the figure, the setting value data to be transmitted together with the enable signal “SEN” and the synchronous clock signal “SCK”, being the so-called serial data signal “SDT”, it is provided with, for example, a mask selection data “mi” of two (2) bits, for indicating which mask data should be selected, at the head thereof, but it is constructed in the same to the mentioned above, i.e., disposing the address data “a” and the setting data “d” in rear thereof.

With such the analog signal processor according to the third embodiment, it is possible to cause the registers 8 to output the desired mask data into the AND-OR logic circuit portion 6, together with the data stored within the desired address, by means of the address data within the address register 3 and the mask selection data “mi” provided at the head thereof. However, it is also same to that in the embodiment mentioned above, that the AND-OR logic circuit portion 6 further inputs the setting data “d” within the data register, thereby to execute the operation presented by the logical operation equation [Eq. 1] mentioned above, upon the data “ra” obtained from the register 8, to which access is made on the basis of the address data “a”. Namely, with this third embodiment, in the same manner as was mentioned above, it is also possible to achieve the re-writing of the contents, selectively, upon the data at the address within the registers 8, to which access is made with the address data “a”, in accordance with the mask data designated by the mask selection signal “mi” mentioned above.

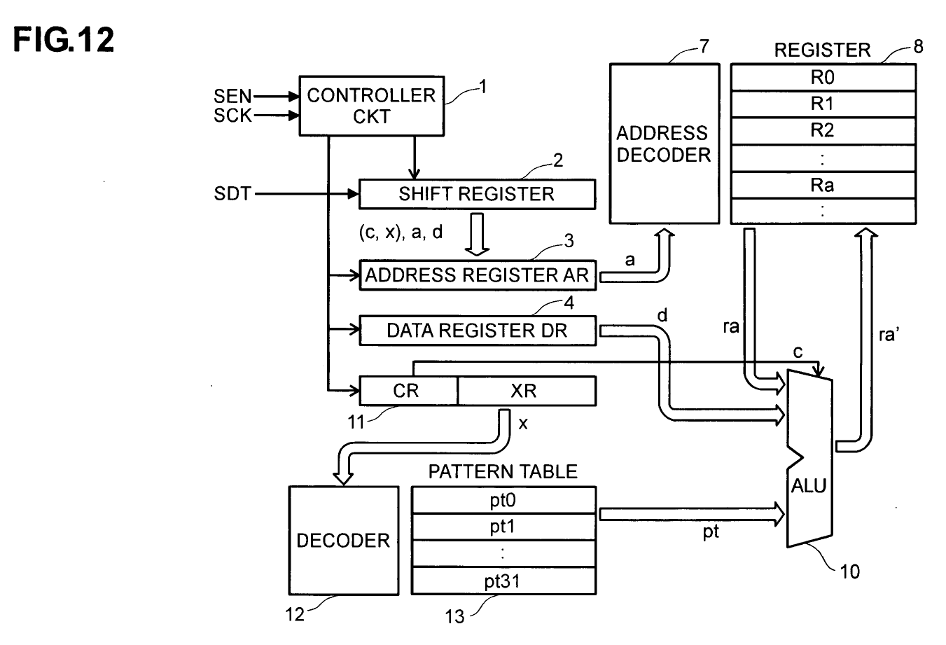

FIG. 12 shows the analog signal processor according to a fourth embodiment of the present invention. However, in this figure, the same reference numerals in the FIG. 1 mentioned above depicts the same constituent elements, and therefore the detailed explanation thereof will be omitted, herein. Thus, in this fourth embodiment, as is apparent from the figure, there are provided a command bit pattern selection register 11, a pattern selection register 12 and a pattern table 13, in the place of the mask register (MR) 5 mentioned above, and further, in the place of the AND-OR logic circuit portion 6 mentioned above, there is provided an arithmetic logical operation circuit or unit (ALU) 10, which is able to make plural numbers of operation processes, selectively. Also, the operation of this arithmetic logical operation circuit or unit (ALU) 10 is determined by data “c” of three (3) bits, which is held within “CR” in a part of the command bit pattern selection register 11, though it will be mentioned in details thereof later.

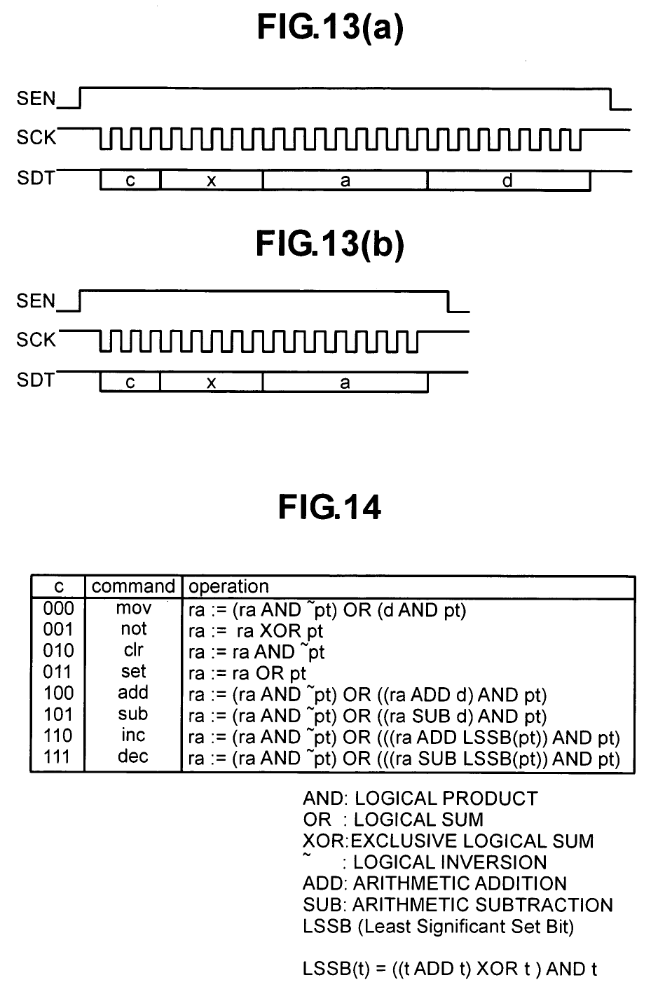

On a while, FIGS. 13(a) and 13(b) show the structure (i.e., the data protocol) of the serial data to be transmitted from the system controller side to this analog signal processor according to the fourth embodiment. Namely, in this fourth embodiment, normally, as is shown in FIG. 13(a), the setting value data to be transmitted together with the enable signal “SEN” and the synchronous clock signal “SCK”, i.e., the serial data signal “SDT”, it is constructed with providing data made of eight (8) bits, in total, i.e., including data “c(CR)” made of three (3) bits mentioned above, for indicating the operation contents, at the head thereof, and data “x (XR)” of five (5) bits for selecting the mask data to be used in that operation, and in rear thereof, there are disposed the address data “a” and the setting data “d”, too.

With the analog signal processor mentioned above, according to the fourth embodiment, in the similar manner to the above, first the serial data “SDT” inputted together with the enable signal “SEN” and the synchronous clock signal “SCK” is held within the shift register 2, once, and then shifted into the address register 3, the data register 4, and the command bit pattern selection register 11, to be held therein, respectively, depending upon the control output of the controller circuit 1. And, it is almost same to that mentioned above, that the data “ra” of eight (8) bits, which is stored at the desired address within the registers 8, is read out therefrom, through the address decoder 7, in accordance with the address data “a” of eight (8) bits held in the address register 3, to be supplied into the arithmetic logical operation circuit or unit (ALU) 10, together with the setting data “d” held within the data register 4.

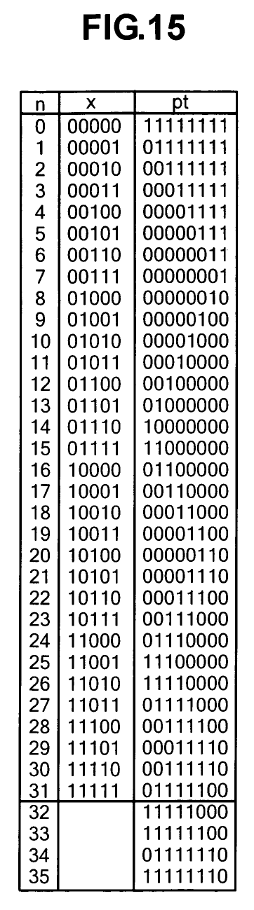

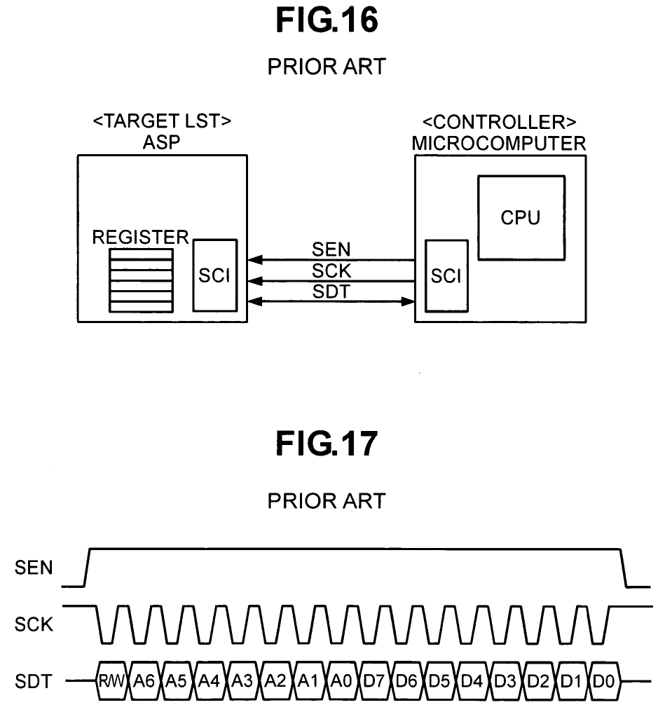

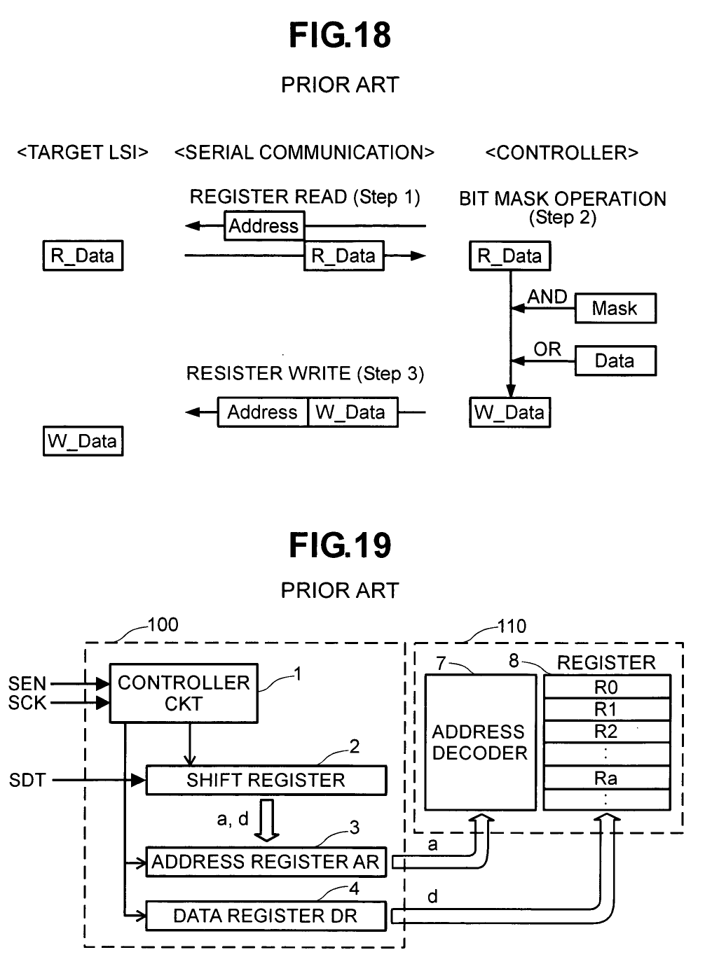

And, in this fourth embodiment, the data “c” at the upper three (3) bits (CR) within the command bit pattern selection register 11 is guided to the control terminal of the arithmetic logical operation circuit or unit (ALU) 10 mentioned above, and thereby setting up or determining the logical operation to be executed by the arithmetic logical operation circuit. Further, more details of an example of the commands (command) indicated by the data “c” of three (3) bits and the operations (operation) to be executed by those commands are shown in FIG. 14. Also, at the same time, an index data “x” of the lower five (5) bits (XR) within the command bit pattern selection register 11 is inputted into the pattern selection register 12, so that pattern data “pt” stored at the address designated by the index data “x” is taken out from the pattern table 13. Further in FIG. 15, there is shown an example of the data “x” and the pattern data “pt” corresponding thereto, in more details thereof. However, this pattern data is data logically opposite to the mask data shown in the embodiments 1 through 3. There are shown 36 pieces of patterns, which can be obtained theoretically from the mask pattern made of eight (8) bits, under the condition of assigning plural numbers of bits into continuous bits, however in the pattern table 13 shown in the FIG. 12 mentioned above, there are stored 32 pieces of patterns (from “pt0” to “pt31”), which are selected by assigning the continuous bits equal or greater than five (5) bits into the lower bits, among those 36 pieces of patterns.

Thus, with the fourth embodiment mentioned above, the logical operation to be executed by the arithmetic logical operation circuit or unit (ALU) 10 is determined by the data “c” at the upper three (3) bits, which are provided prior to the address data “a” of the serial data signal “SDT”, and further, the pattern “pt” can be selected at desire among the large numbers of mask patterns, by means of the data “x” within the lower five (5) bits thereof. With this, it is possible to deal with the various setting and setting values stored with the registers 8 mentioned above, widely and flexibly, so as to re-write only the bit(s) necessary of being re-written on the contents thereof. However, it is same to that the mentioned above, that the arithmetic logical operation circuit or unit (ALU) 10, further inputting the setting data “d” within the data register, executes the operation upon the data “ra” obtained from the register, to which access is made upon the basis of the address data “a”, in accordance with the logical operation equation determined.

Also, though the structure of the normal serial data signal is shown in the FIG. 13(a) mentioned above, however in the case of trying to set all of the bits to be changed into “0” or “1”, for example, there is no need of such the setting data “d” mentioned above, and in such the case, as is shown in the FIG. 13(b), it is sufficient to dispose the address data “a”, following to the data “c (CR)” of three (3) bits and the data “x” of five (5) bits mentioned above. By taking the example of the arithmetic logical operation shown in FIG. 14, “mov”, “add” and “sub” need “d”, but the remaining “not”, “clr”, “set”, “inc” and “dec” need not “d”. Namely, if applying such the data structure therein, appropriately, it is possible to achieve the communication at higher speed, through the serial communication, but without necessity of conducting the “Read Modify Write” process, between the ASP and the controller.

As was fully explained in the above, according to the analog signal processor, according to the present invention, and further the data register re-wiring method thereof and the data transmission method for it, there is no necessity of processing for reading out the register on the controller side, representatively, such as, the “Read Modify Write”, which is needed in relation to the conventional art, for example, and therefore, it is possible to achieve the selective bit setting into the register to be accessed within the analog signal processor, at high speed, but at that instance, there is made no requirement of increasing the processing speed to the controller side.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. An analog signal processor, inputting a serial signal for setting data for use of analog setting, comprising:
a data register of a predetermined bit length, for holding the data for use of analog setting therein;
an address decoder for managing access to said data register;
an extracting circuit for extracting an address signal for specifying an address within said data register, a data signal to be written into the address specified within said data register, and a mask signal for designating a specific bit of the address specified within said data register, from the serial signal inputted therein; and
a re-writing circuit for selectively re-writing the data of the specific bit designated, at the address specified within said data register, upon basis of the address signal, the data signal and the mask signal, which are extracted by said extracting circuit.

2. The analog signal processor, as described in the claim 1, wherein said re-writing circuit conducts a process of logical operation upon the data to be written into the address specified within said data register, through a logical operation between said data signal and said mask signal.

3. The analog signal processor, as described in the claim 2, wherein said re-writing circuit conducts the logical operations of AND and OR.

4. The analog signal processor, as described in the claim 1, wherein said serial signal to be inputted further includes a signal for specifying a logical operation to be performed, and said re-writing circuit executes the logical operation specified by said logical operation specifying signal upon said data signal and said mask signal, thereby writing them into said address specified within said data register.

5. The analog signal processor, as described in the claim 1, wherein said extracting circuit has a shift register.

6. The analog signal processor, as described in the claim 1, wherein said extracting circuit further includes an address register for inputting and holding said address signal therein, a data register for inputting and holding said data signal therein, and a mask register for inputting and holding said mask signal therein.

7. A data register re-writing method, for rewriting data for use of analog setting, which is held within a data register of a predetermined bit length provided within an analog signal processor, comprising the following steps of:
inputting data for setting up the data for use of analog setting into the analog signal processor through a serial communication from an outside;
extracting an address signal for specifying an address within said data register, a data signal to be written into the specified address within said data register, and a mask signal for designating a specific bit of the address specified within said data register, from the serial signal inputted; and
re-writing data of the designated specific bit at said specified address within said data register, selectively, upon basis of said address signal, said data signal and said mask signal.

8. The data register re-writing method, as described in the claim 7, wherein a logical operation is processed upon the data to be written into the specified address within said data register, through logically operating said data signal and said mask signal.

9. The data register re-writing method, as described in the claim 8, wherein the logical operation processed upon said data signal and said mask signal is selectable.

10. A data transmission method, in accordance with serial communication, for rewriting data for use of analog setting, which is held with in a data register of a predetermined bit length provided within an analog signal processor, comprising the following steps of:
inputting data for setting up the data for use of analog setting into the analog signal processor through a serial communication from an outside; and
communicating a serial signal, including an address signal for specifying an address within said data register, a data signal to be written into the specified address within said data register, and also a mask signal for designating a specific bit of the address specified within said data register.
